(19) United States
(12) Patent Application Publication
(10) Pub. No.: US 2012/0287159 A1
(43) Pub. Date: Nov. 15, 2012

(54) VIEWING OF REAL-TIME, COMPUTER-GENERATED ENVIRONMENTS

(75) Inventor: Matthew David BETT, Tayside (GB)

(73) Assignee: University Court of the University of Abertay Dundee, Dundee (GB)

(21) Appl. No.: 13/553,989

(22) Filed: Jul. 20, 2012

Related U.S. Application Data
(63) Continuation of application No. PCT/GB2011/051261, filed on Jul. 5, 2011.

(30) Foreign Application Priority Data
Jul. 14, 2010 (GB) 1011879.2
Nov. 8, 2010 (GB) 1018764.9

(51) Int. Cl. G09G 5/00

(52) U.S. Cl. 345/633

(57) ABSTRACT

A method of generating a view of a computer-generated environment using a location in a real-world environment, comprising receiving real-time data regarding the location of a device in the real-world environment; mapping the real-time data regarding the device into a virtual camera within a directly-correlating volume of space in the computer-generated environment; updating the virtual camera location using the real-time data, such that the virtual camera is assigned a location in the computer-generated environment which corresponds to the location of the device in the real-world environment; and using the virtual camera to generate a view of the computer-generated environment from the assigned location in the computer-generated environment.

### CROSS-REFERENCE TO RELATED APPLICATIONS

This application is a continuation of International Application No. PCT/GB2011/051261, filed Jul. 5, 2011, which claims priority to Great Britain Application No. 1011879.2, filed Jul. 14, 2010 and Great Britain Application No. 1018764.9, filed Nov. 8, 2010, of which the entire contents of each are hereby incorporated fully by reference.

### TECHNICAL FIELD

This invention relates to viewing of real-time, computer-generated environments, particularly the direct relationship of manipulation of the location of a device in a real-world environment to the manipulation of the view of a computer-generated environment.

### BACKGROUND OF THE INVENTION

Computer-generated environments are used in a variety of applications. The most well-known application of computer-generated environments is the creation of computer games, but such environments are also used e.g. for training purposes, e.g. training of aircraft pilots or medical personnel. In these computer-generated environments, the environment is generally viewed from a location of a viewpoint or a ‘virtual camera’ which is mathematically defined within the computer-generated environment.

User control over the location of the virtual camera is determined by user interaction with external peripheral hardware such as a game controller. For certain applications, conventional hardware imposes restrictions on how the user can view the environment and in what way they can manipulate this virtual camera.

### SUMMARY OF THE INVENTION

According to a first aspect of the invention there is provided a method of generating a view of a computer-generated environment using a location in a real-world environment, comprising receiving real-time data regarding the location of a device in the real-world environment; mapping the real-time data regarding the device into a virtual camera within a directly-correlating volume of space in the computer-generated environment; updating the virtual camera location using the real-time data, such that the virtual camera is assigned a location in the computer-generated environment which corresponds to the location of the device in the real-world environment; and using the virtual camera to generate a view of the computer-generated environment from the assigned location in the computer-generated environment.

It will be appreciated that the device may be moved from location to location in the real-world environment. The method may then comprise receiving real-time data regarding locations of the device in the real-world environment, mapping the real-time data regarding the locations of the device into the virtual camera within a directly-correlating volume of space in the computer-generated environment, updating the virtual camera locations using the real-time data, such that the virtual camera is assigned locations in the computer-generated environment which correspond to the locations of the device in the real-world environment, and using the virtual camera to generate views of the computer-generated environment from the assigned locations in the computer-generated environment.

According to a second aspect of the invention there is provided a system for generating a view of a computer-generated environment using one or more locations in a real-world environment, comprising a device in the real-world environment whose location in that environment can be determined; a detector which determines one or more locations of the device in the real-world environment; a processor which translates the location or locations of the device in the real-world environment into a location or locations within a directly-correlating volume in the computer-generated environment; and a virtual camera in the computer-generated environment which is assigned the location or locations in the computer-generated environment and which generates a view or views of the computer-generated environment from the assigned location or locations in the computer-generated environment.

The system may further comprise a virtual rig in the computer-generated environment, wherein the virtual rig is coupled with the virtual camera such that the virtual rig and virtual camera are assigned a same first location in the computer-generated environment and a location or locations subsequently assigned to the virtual camera are determined with reference to the first location.

The device in the real-world environment may be thought of as representing a virtual camera in the real-world environment. Thus the invention deals with location of the virtual camera in the computer-generated environment by using locations of a virtual camera in the real-world environment.

The device in the real-world environment may also be thought of as representing a virtual rig in the real-world environment. Thus the invention deals with location of the virtual rig in the computer-generated environment by using locations of a virtual rig in the real-world environment.

The location of the device in the real-world environment may comprise the position and orientation of the device in the real-world environment. Similarly, the location of the virtual camera in the computer-generated environment may comprise the position and orientation of the virtual camera in the computer-generated environment. Furthermore, the location of the virtual rig in the computer-generated environment may comprise the position and orientation of the virtual rig in the computer-generated environment.

The device in the real-world environment may be calibrated for determination of its initial location in the real-world environment. The device may be a self-contained device or a peripheral device. The device is intended to be held by a user of the invention. The device is intended to be operated in a fashion similar to that which the user would employ when:

using a real-world rig on which a real world camera is disposed; or

holding a real-world camera.

This facilitates the direct translation of established camera-work skills and techniques into the virtual system of the invention.

The device in the real-world environment may comprise a fiducial marker. The fiducial marker may comprise a passive device whose location in the real-world environment can be determined. The fiducial marker may be integrated with an active device which has a motion controller element which more accurately determines its location in the real-world environment, for example by use of accelerometers or gyroscopes.

When the device in the real-world environment comprises a fiducial marker, the detector which determines locations of the device in the real-world environment may comprise a vision-based system in the real-world environment. The detector may determine the locations of the marker in the real-world environment by visually detecting the location of the fiducial marker in the real-world environment.

The device in the real-world environment may comprise a motion controller. The motion controller may be entirely active to determine its location in the real-world environment. The motion controller may comprise an active element, for example one or more electromagnetic elements for determination of its location in the real-world environment. The motion controller may further include a video viewfinder, the view from which corresponds to the virtual camera view in the computer-generated environment. The motion controller may be part of a system which includes a suite of buttons and other control mechanisms which can be utilised to control other aspects of the controller typical of a real-world camera, such as zoom and focus.

When the device in the real-world environment comprises a motion controller, the detector which determines locations of the device in the real-world environment may comprise one or more electromagnetic sensors which detect the motion controller 3.

The detector which determines locations of the device in the real-world environment may define a real-world environment capture volume, in which positions of the device are captured.

The system may further comprise a motion capture camera system which captures locations of a user and/or objects in the real-world environment. The motion capture camera system may comprise stereo or mono cameras, one or more infra red or laser rangefinders and image processing technology to perform real-time capture of the locations of the user and/or the objects in the real-world environment. The motion capture camera system may capture the positions, in two or three dimensions, of various limbs and joints of the body of the user, along with their roll, pitch, and yaw angles. The motion capture camera system may define a real-world environment user capture volume, in which positions of the user are captured. The real-world environment user capture volume may be limited by the view angle of the mono or stereo cameras and the depth accuracy of the laser/infra red rangefinders or other depth determining system of the motion capture camera system.

The processor may perform mathematical translation of the location or locations of the device in the real-world environment into a location or locations in the computer-generated environment. The processor may perform interpolation and filtering of the real-time data regarding the location of the device in order to compensate for errors and simulate behaviours of real camera systems, e.g. a steadycam system. The processor may perform mathematical translation of the real-time data regarding the device into formats necessary for computer graphics hardware corresponding to the position, orientation and other effects, such as zoom, focus, blur, of the virtual camera of the computer-generated environment. The processor may perform tracking and prediction of the location of the device in order to improve performance or achieve certain effects for the virtual camera of the computer-generated environment.

The processor for the computer-generated environment may define a computer-generated environment view volume. The view volume may be generated on instructions from a user of the invention. The processor may be able to change the dimensions of the computer-generated environment view volume. The view volume may correspond in a defined way with the real-world environment capture volume. The user is thus offered a multitude of scaling options between the computer-generated environment and the real-world environment. For example, the user may choose and the processor may define a computer-generated environment view volume which has a 1-1 ratio with the real-world environment capture volume. This gives the user the control they would expect if the computer-generated environment they are viewing was the full size of the real-world environment.

The user may choose and the processor may define a computer-generated environment view volume which is enlarged in comparison to the real-world environment capture volume. This allows the user to perform different camera work, perhaps a flyby through a part of the computer-generated environment view volume. This means the experience is analogous to shooting a miniature model (rather than a full-scale set) with a hand-held camera.

The processor may lock the computer-generated environment view volume to an object in that environment. This allows the user to accomplish dolly or track camera work. The processor may be used by the user to manipulate, for example transform, scale or rotate, the computer-generated environment view volume with respect to the real-world environment capture volume.

The virtual camera may undergo relative updating of its location. The virtual camera may undergo absolute updating of its location. The virtual rig may undergo relative updating of its location. The virtual rig may undergo absolute updating of its location.

The virtual camera may set the view in the computer-generated environment to directly correspond to the translated real-world location of the device. The virtual camera may comprise controls which provide degrees of freedom of movement of the virtual camera in addition to position and orientation thereof. The virtual camera is then capable of reproducing techniques and effects analogous to a real camera. The virtual camera may apply other user-defined inputs which correspond to the use and effects of a real camera system.

The virtual camera of the computer-generated environment may be provided with one or more different camera lens types, such as a fish-eye lens. The virtual camera may be provided with controls for focus and zoom. These may be altered in real time and may be automatic. The virtual camera may be provided with one or more shooting styles, for example a simulated steady-cam which can smooth out a user's input, i.e. motion, as a real steady-cam rig would do.

The virtual camera may be used to lock chosen degrees of freedom or axes of rotation, allowing the user to perform accurate dolly work or panning shots. For example, the ‘dolly zoom’ shot synonymous with Jaws and Vertigo could be easily achieved by restricting the freedom of the camera in certain axes and manipulating the device in the real-world environment whilst simultaneously zooming in/out at a set speed as required.

The system may comprise a voice command receiver with voice recognition or natural language processing capability. The system may receive voice commands which the processor for the computer-generated environment may use to control the virtual camera, for example to instruct it to start shooting, record etc.

### BRIEF DESCRIPTION OF THE DRAWINGS

An embodiment of the invention will now be described by way of example only, with reference to the accompanying drawings, in which:

FIG. 1 is a schematic representation of a system according to the invention for generating a view of a computer-generated environment using a location in a real-world environment;

FIG. 2 is a flow chart describing a method according to the invention of generating a view of a computer-generated environment using a location in a real-world environment; and

FIG. 3 is a flow chart providing a more detailed view of a one or more transformations performed in the method shown in FIG. 2.

### DETAILED DESCRIPTION OF AN EMBODIMENT OF THE INVENTION

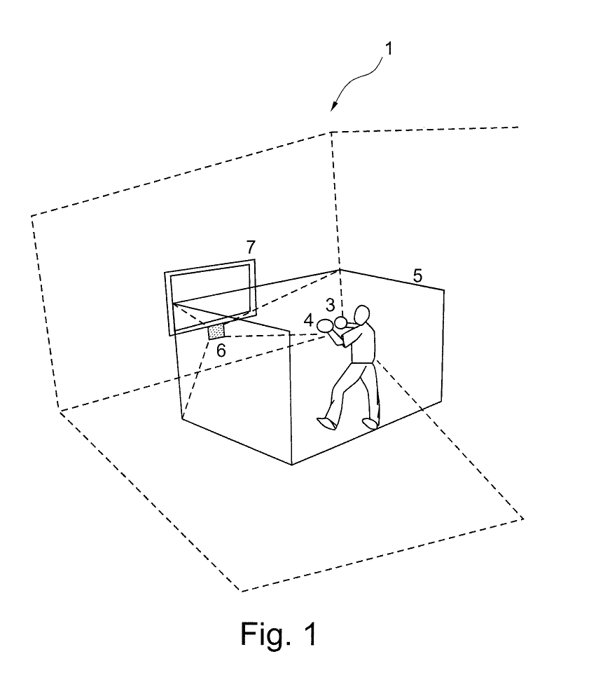

Referring to FIG. 1, a schematic representation of a system according to the invention is shown. The system generates views of a computer-generated environment using locations in a real-world environment. The real-world environment is represented by the view of a room. The computer-generated environment is represented by the view shown on the television screen in the room. The system 1 comprises a first device 3 and a second device 4 in the real-world environment. In this embodiment, the first device is a first motion controller 3 and the second device is a second motion controller 4. The first motion controller 3 and the second motion controller 4 may be respectively thought of as the virtual rig and the virtual camera in the real-world environment.

The first motion controller 3 and the second motion controller 4 may be embodied in and switchably activated from a single handset (or other suitable user device) held by a user of the system. Alternatively, the first motion controller 3 and the second motion controller 4 may be embodied in separate handsets (or other suitable user devices). In either case, the first motion controller 3 and the second motion controller 4 may each comprise an active device whose location in the real-world environment can be determined. Alternatively, the first motion controller 3 or the second motion controller 4 may comprise a simple forward/backward joystick (or other suitable controller) and the other motion controller may comprise an active device whose location in the real-world environment can be determined.

For ease of understanding, and to accentuate the distinction between control of the virtual rig and control of the virtual camera, the following discussion shall focus on the example comprising two separate handsets (or other suitable devices).

The system 1 comprises a detector 6 which determines the location of either or both of the first motion controller 3 and the second motion controller 4 in the real-world environment. In this embodiment, the detector 6 comprises an electromagnetic sensor. The detector 6 defines a real-world environment capture volume 5 and captures the locations of either or both of the first motion controller 3 and the second motion controller 4 as it or they are moved in the capture volume 5 by the user. In this embodiment, the capture volume 5 has a volume of approximately 4 m2. However, it will be realised that the system is in no way limited to this capture volume. On the contrary, the system's capture volume is expandable as required, subject only to the hardware constraints of the detector. The detector 6 captures the positions and orientations of either or both of the first motion controller 3 and the second motion controller 4, in three dimensions and three axes of rotation in the capture volume 5.

The system 1 further comprises additional buttons and controls on either or both of the first motion controller 3 and the second motion controller 4. These additional buttons and controls allow the user further modes of control input (including, without limitation, up and down movements, zoom control, tripod mode activation/deactivation, aperture control and depth of field control (to allow soft focus techniques)).

The system 1 comprises a processor (not shown) which controls the specification and creation of the computer-generated environment. The processor for the computer-generated environment communicates with the hardware of the detector to receive locations, specifically positions and orientations, of either or both of the first motion controller 3 and the second motion controller 4 in the real-world environment. The processor comprises algorithms that translate the locations of either or both of the first motion controller 3 and the second motion controller 4 in the real-world environment into locations in the computer-generated environment. In other words, the algorithms map real-time data regarding the locations of either or both of the first motion controller 3 and the second motion controller 4 in the capture volume 5 of the real-world environment into locations in the computer-generated environment.

The locations of either or both of the virtual rig (not shown) and the virtual camera (not shown) of the system 1 are updated using the mapped locations in the computer-generated environment. In other words, either or both of the virtual rig and the virtual camera is assigned the mapped locations of either or both of the first motion controller 3 and the second motion controller 4 in the computer-generated environment. The updating and positioning of either or both of the virtual rig and the virtual camera can be based on relative or absolute location information derived from the location data of either or both of the first motion controller 3 and the second motion controller 4.

The virtual camera creates views of the computer-generated environment from its assigned locations within the computer-generated environment. In this embodiment, the system 1 further comprises a television screen 7 to display the view of the virtual camera within the computer-generated environment to the user of the system.

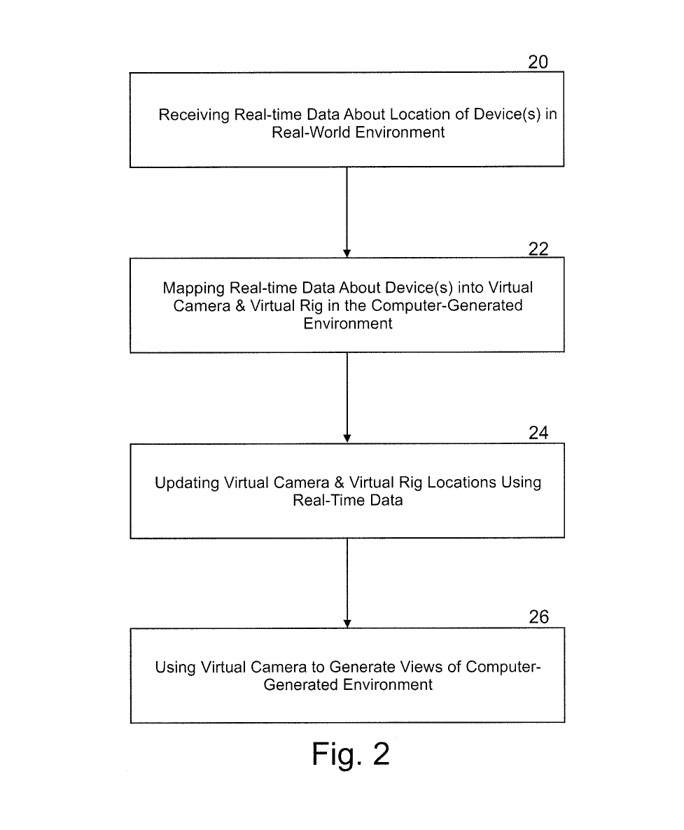

Referring to FIG. 2 together with FIG. 1, the method of the invention of generating a view of a computer-generated environment using a position in a real-world environment, will now be described.

The method first comprises receiving 20 real-time data regarding the location of one or more devices (i.e. either or both of the first motion controller 3 and the second motion controller 4) in the real-world environment.

The method then comprises mapping 22 the real-time data regarding the device(s) to the locations of either or both of a virtual camera and virtual rig within a directly-correlating volume of space in the computer-generated environment. The method then comprises updating 24 either or both of the virtual camera and virtual rig locations using the real-time data, such that either or both of the virtual camera and virtual rig is assigned locations in the computer-generated environment which correspond to locations of the device(s) in the real-world environment. The virtual camera then generates 26 views of the computer-generated environment from its assigned location in the computer-generated environment.

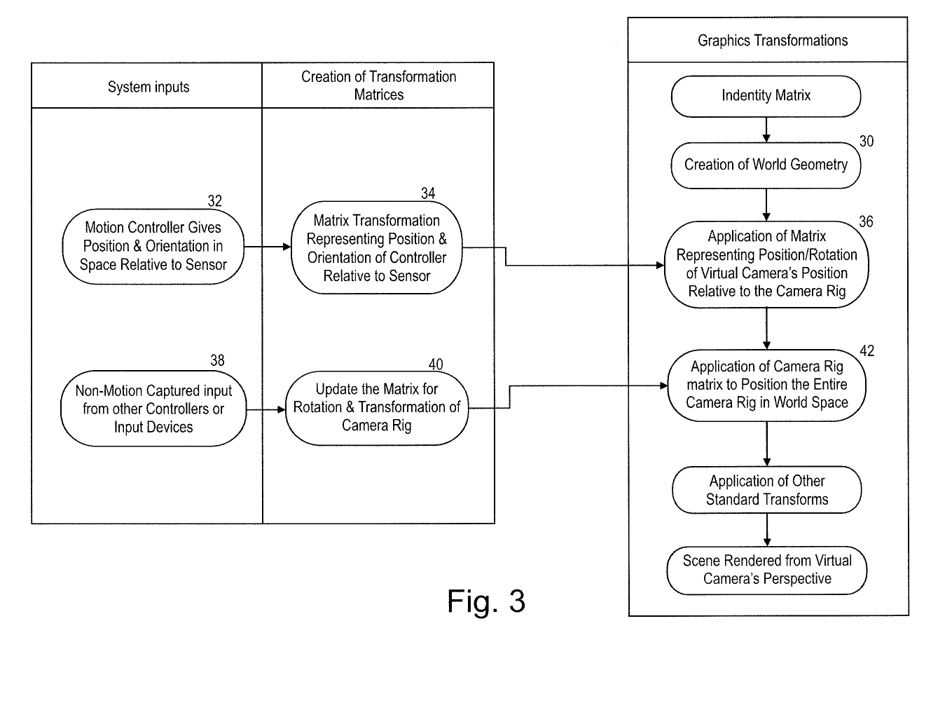

FIG. 3 provides a more detailed explanation of the steps of the method shown in FIG. 2. In particular, referring to FIG. 3, prior to receiving real-time data from the or each of the first and second motion controllers, the method comprises an initialisation step 30 of creating the geometry of the computer-generated environment. Thereafter, an initial location is established (not shown) for the virtual rig in the computer-generated environment. For simplicity, this initial location will be referred to henceforth as the rig start location.

The virtual camera is coupled with the virtual rig in the same way as a camera is mounted on a rig in a real-world environment. This coupling is achieved by providing the virtual rig with its own volume (henceforth known for clarity as the rig volume) and associated local co-ordinate system (in which the virtual rig forms the origin); and substantially constraining movement of the virtual camera to the rig volume. Thus, the establishment of an initial location for the virtual rig in the computer-generated environment leads to the establishment of a corresponding initial location for the virtual camera in the computer-generated environment. For simplicity, this initial position will be referred to henceforth as the camera start location. The above-mentioned coupling between the virtual rig and the virtual camera ensures that subsequent movements of the virtual camera in the computer generated environment, are determined with reference to the current location of the virtual rig therein.

In the example provided in FIG. 3, movement of the virtual camera is achieved through an active device whose position and orientation in the real-world environment is detected and translated into a position and orientation in the computer-generated environment. In contrast, movement of the virtual rig is controlled through a joystick or switch etc. (the control signals from which are known for simplicity as non-motion captured input). However, it will be understood that the method of the present invention is not constrained to these control mechanisms. Indeed, the position and orientation of the virtual rig in the computer generated environment could be established from the position and orientation of an active device in the real-world environment, in the same way as the afore-mentioned virtual camera.

Returning to the example shown in FIG. 3, the active device provides 32 information regarding its position and orientation in the real-world environment relative to a sensor. The method comprises the step of generating 34 from this information a transformation matrix which represents a mapping of the position and orientation of the active device (with reference to the sensor), to a corresponding position and orientation of the virtual camera (with reference to the virtual rig) in the computer generated environment. The method comprises the further step of applying the transformation matrix 36 to the rig volume to relocate the virtual camera therewithin.

The method further comprises the step of receiving 38 a non-motion captured input and using 40 this input to update a transformation matrix representing a current position and orientation of the camera rig in the computer-generated environment. The method comprises the step of applying 42 the updated transformation matrix to the computer-generated environment to relocate the virtual rig (and correspondingly the virtual camera) therein.

The example shown in FIG. 3 is of a standard pre-multiplicative system, wherein the successive implementation of the above method steps leads to a hierarchical system of transforms. Nonetheless, the skilled person will understand that the method of the present invention is not limited to a pre-multiplicative system. On the contrary, the method of the present invention can be equally implemented as a pre-multiplicative or a post-multiplicative system.

The provision by the method and system of the present invention, of a movable virtual rig and a movable virtual camera coupled thereto, provides a particularly flexible mechanism for setting up desired shots. For example, in a virtual tripod mode, the virtual rig can be positioned where required in the computer-generated environment and the virtual camera aimed at the item to be viewed. Similarly, the virtual camera can be set to move in a fixed dolly (which the user can define quickly in the computer-generated environment by choosing an aim direction and visual guides indicate the dolly direction). This dollying of the virtual rig opens up many shooting possibilities and can be used in conjunction with the virtual tripod mode for a steady dolly.

### Examples of Use

### Replay of Game Action

In a first example, the system of the present invention is used to deliver an action game. Say for example a player of the game (using an entirely conventional controller) experiences a unique moment or otherwise interesting event in the game. Using a replay feature of the system, the player's actions as a virtual player are recounted and the player is enabled to film the replay footage using the virtual camera locations of the invention. In particular, the system permits the player to:
select a timeframe of the replay footage
sets the computer-generated environment view volume (e.g. computer-generated environment view volume which has a 1-1 ratio with the real-world environment capture volume)

The system then permits the player to move either or both of the first motion controller and second motion controller in the real-world environment capture volume 5, the movements of either or both of the first motion controller and second motion controller being used to update the location of either or both of the virtual rig and the virtual camera in the computer-generated environment. The virtual camera creates views of the computer-generated environment and the in-game actions from its updated location. The system and method of the present invention displays to the user the views of the computer-generated environment and the selected in-game actions.

By translating further movements made by the user of either or both of the first motion controller and the second motion controller into viewing locations in the computer-generated environment, the method and system of the present invention also permits the player to walk around within the confines of the view volume of the computer-generated environment and explore shooting possibilities of his actions until deciding to record. Starting playback, the player has freedom to move the viewing location within the computer-generated environment view volume as the scene of his actions plays out. This allows the player to capture his actions from the best viewing location or locations exploiting cinematic techniques, rather than being limited to pre-set viewing locations in the computer-generated environment.

### Film-Making

The system of the invention is entirely virtual, with no integration of real and digital footage. The system and method of the invention allows users to shoot in-game footage of live game play or action replays using conventional camera techniques.

When viewing a virtual environment, users are traditionally limited to mouse or other controller style input to alter a view. Whilst this fine for shooting people, the movement can come across as very robotic (and since its main use is for gameplay) constrained in some way. However, the system and method of the present invention permits the manipulation of a view in a much more organic manner (i.e. akin to if it had been shot with a portable camcorder). For example, the system and method of the present invention permits the inclusion of realistic, organic and jerky-style filming effects into live-action scenes (e.g. combat sequences), wherein conventional rendering techniques would have produced smoother and less exciting transitions and movements.

More generally, the system and method of the present invention permits the inclusion of very film shots into a game, which simply couldn't be done before, because the cost of the equipment needed (i.e. specialist film equipment) would have been too prohibitive.

The invention is directed at enthusiasts of the “Machinima” genre of videos and also serious filmmakers. The techniques of the invention are compatible with multiple different types of hardware. Aside from games consoles comprising specialised motion detection hardware, the techniques of the invention can be applied to any system using a ‘game engine’ style system for visualising 3d graphics. The system of the invention is cost-effective, allowing the home enthusiast access to the features of the invention at a minimal expense.

### Visualization and Education

The technology of the invention is primarily intended to be exploited in future games console titles as an additional feature, much like existing tools used to create Machinima. In this case, the use of the invention would not impact game play or require any re-working of the game to accommodate it. In addition, there is also scope for custom software to be created around the virtual camera in real-world environment concept, that further exploits its benefits for more serious film production and more logically editing software specific to the console.

Other applications of the method and system of the invention include the visualisation of complex, hazardous objects or simply things that would otherwise be impossible to bring into the classroom for educational purposes. For example, the method and system of the invention would enable a user to effectively fly-through and view internal mechanisms of a small block engine. Further applications of the method and system of the invention include medical education wherein motion controllers can be used to interact with anatomical and/or physiological models in real-time. In this context, the method and system of the present invention can also be used to demonstrate incision points, problem areas and aspects of medical procedures.

Alterations and modifications may be made to the above, without departing from the scope of the invention.

1. A method of generating a view of a computer-generated environment using a location in a real-world environment, comprising
receiving real-time data regarding the location of a device in the real-world environment;
mapping the real-time data regarding the device into a virtual camera within a directly-correlating volume of space in the computer-generated environment;
updating the virtual camera location using the real-time data, such that the virtual camera is assigned a location in the computer-generated environment which corresponds to the location of the device in the real-world environment; and
using the virtual camera to generate a view of the computer-generated environment from the assigned location in the computer-generated environment.

2. A system for generating a view of a computer-generated environment using one or more locations in a real-world environment, comprising
a device in the real-world environment whose location in that environment can be determined;
a detector which determines one or more locations of the device in the real-world environment;
a processor which translates the location or locations of the device in the real-world environment into a location or locations within a directly-correlating volume in the computer-generated environment; and
a virtual camera in the computer-generated environment which is assigned the location or locations in the computer-generated environment and which generates a view or views of the computer-generated environment from the assigned location or locations in the computer-generated environment.

3. The system as claimed in claim 2, wherein the system further comprises a virtual rig in the computer-generated environment, wherein the virtual rig is coupled with the virtual camera such that the virtual rig and virtual camera are assigned a same first location in the computer-generated environment and a location or locations subsequently assigned to the virtual camera are determined with reference to the first location.

4. The system as claimed in claim 2, wherein the location of the virtual camera in the computer-generated environment may comprise the position and orientation of the virtual camera in the computer-generated environment.

5. The system as claimed in claim 2, wherein the device in the real-world environment is calibrated for determination of its initial location in the real-world environment.

6. The system as claimed in claim 2, wherein the device is a self-contained device or a peripheral device.

7. The system as claimed in claim 2, wherein the device in the real-world environment comprises a motion controller.

8. The system as claimed in claim 7, wherein the motion controller comprises an active element for determination of its location in the real-world environment.

9. The system as claimed in claim 7, wherein the motion controller further includes a video viewfinder, the view from which corresponds to the virtual camera view in the computer-generated environment.

10. The system as claimed in claim 7, wherein the detector which determines locations of the device in the real-world environment comprises one or more electromagnetic sensors which detect the motion controller.

11. The system as claimed in claim 2, wherein the detector which determines locations of the device in the real-world environment defines a real-world environment capture volume, in which positions of the device are captured.

12. The system as claimed in claim 2, wherein the system further comprises a motion capture camera system which captures locations of a user and/or objects in the real-world environment.

13. The system as claimed in claim 12, wherein the motion capture camera system comprises stereo or mono cameras, one or more infra red or laser rangefinders and image processing technology to perform real-time capture of the locations of the user and/or the objects in the real-world environment.

14. The system as claimed in claim 12, wherein the motion capture camera system captures the positions, in two or three dimensions, of various limbs and joints of the body of the user, along with their roll, pitch, and yaw angles.

15. The system as claimed in claim 12, wherein the motion capture camera system defines a real-world environment user capture volume, in which positions of the user are captured.

16. The system as claimed in claim 15, wherein the real-world environment user capture volume is limited by the view angle of the mono or stereo cameras and the depth accuracy of the laser/infra red rangefinders or other depth determining system of the motion capture camera system.

17. The system as claimed in claim 2, wherein the processor is adapted to perform mathematical translation of the location or locations of the device in the real-world environment into a location or locations in the computer-generated environment.

18. The system as claimed in claim 2, wherein the processor is adapted to perform interpolation and filtering of real-time data regarding the location of the device in order to compensate for errors and simulate behaviours of real camera systems.

19. The system as claimed in claim 2, wherein the processor is adapted to perform mathematical translation of real-time data regarding the device into formats necessary for computer graphics hardware corresponding to the position, orientation and other effects, such as zoom, focus, blur, of the virtual camera of the computer-generated environment.

20. The system as claimed in claim 2, wherein the processor defines a computer-generated environment view volume.

21. The system as claimed in claim 20, wherein the processor locks the computer-generated environment view volume to an object in that environment.

22. The system as claimed in claim 2, wherein the virtual camera undergoes either or both of relative or absolute updating of its location.

23. The system as claimed in claim 2, wherein the virtual camera sets the view in the computer-generated environment to directly correspond to the translated real-world location of the device.

24. The system as claimed in claim 2, wherein the virtual camera comprises controls which provide degrees of freedom of movement of the virtual camera in addition to position and orientation thereof.

25. The system as claimed in claim 2, wherein the virtual camera is provided with one or more different camera lens types, such as a fish-eye lens.

26. The system as claimed in claim 2, wherein the virtual camera is provided with one or more controls focus and zoom.

27. The system as claimed in claim 2, wherein the virtual camera is used to lock chosen degrees of freedom or axes of rotation, thereby allowing a user to perform accurate dolly work or panning shots.
